(19) United States
(12) Patent Application Publication
(10) Pub. No.: US 2008/0280267 A1
(43) Pub. Date: Nov. 13, 2008

(54) CHILD'S ENTERTAINMENT AND EDUCATIONAL TOY

(76) Inventor: Nancy Aldridge, Georgetown (CA)

Correspondence Address: DENNISON ASSOCIATES, 133 RICHMOND STREET WEST, SUITE 301, TORONTO, ON, M5H 2L7, CA

(21) Appl. No.: 12/117,404

(22) Filed: May 8, 2008

Related U.S. Application Data
(60) Provisional application No. 60/916,755, filed on May 8, 2007.

(51) Int. Cl. G09B 19/22; A45F 4/02; G09B 19/00

(52) U.S. Cl. 434/129; 224/577; 434/127

(57) ABSTRACT

An educational toy for use during the routine activity of grocery shopping is provided. The educational toy includes a tote provided with handles to enable it to be carried by a user, the tote having a front portion and a back portion. The tote has a releasable closure means to hold the back and front portions together in a closed position, the closure means in an open position allowing the tote to open similar to a book to reveal at least one pocket on one side in the interior for holding individual items and at least one pocket on the other side for also holding items. The educational toy further includes a plurality of cards having pictures of grocery items thereon. The one side of the interior of the tote is provided with a plurality of individual pockets to hold the cards having pictures of grocery items thereon, the other side has a pocket with a representation of a grocery shopping cart thereon. The cards representing the items on a shopping list in the individual pockets on the one side are removable from the individual pocket on the one side for placement in the pocket with the representation of the grocery cart on the other side thereby imitating grocery shopping.

### FIELD OF THE INVENTION

The present invention relates to an entertainment and educational toy for children to provide for entertaining and teaching of a child during routine activities.

### BACKGROUND OF THE INVENTION

There have been many designs of educational toys for children to teach and entertain the children during routine activities. Examples of such designs are shown in U.S. Pat. Nos. 3,316,669, 4,702,700, 5,827,106, 5,269,691, 2,501,902, and 4,874,340 amongst others. Many of these prior patents describe the use of books and the like being provided with removable and interchangeable articles to teach children language skills, as well as the association of various objects with one another. There still remains a need however, for an entertainment and educational toy, which can teach a child, as well as keeping the child entertained and occupied, while the parent completes a routine task.

### SUMMARY OF THE INVENTION

The present invention is directed to an educational toy for children which can teach a child, as well as keeping the child entertained and occupied, while the parent completes a routine task.

In an aspect of the invention, the educational toy is a tote provided with handles to enable it to be carried by a user. The tote has a front portion and a back portion, held together in a closed position by a closure means. When the closure means is released, the tote opens similar to a book to reveal at least one pocket on one side in the interior for holding individual items and at least one pocket on the other side for also holding items.

In an aspect of the invention, the educational toy is for use during the routine activity of grocery shopping and includes a plurality of cards having pictures of grocery items thereon. The one side of the interior is provided with a plurality of individual pockets to hold cards having pictures of grocery items thereon. The other side has a pocket with a representation of a grocery shopping thereon. The child places the cards representing the items on the parent's shopping list in the individual pockets on the one side. During grocery shopping, as the parent places an item in the shopping cart, the child removes the card for the item from the individual pocket on the one side and places it in the pocket with the representation of the grocery cart on the other side thereby imitating the parent grocery shopping.

In another aspect of the invention, the cards have pictures selected from fruits and vegetables commonly purchased in a grocery store such as potatoes, carrots, tomatoes, broccoli, apples, bananas, grapes, etc.; dairy items such as milk, yogurt, egg, cheese, etc.; grain products such as cereal, bread, crackers, etc.; and miscellaneous items such as soups, peanut butter, jam, pizza and personal care products such as toothpaste, soap, etc.

### BRIEF DESCRIPTION OF THE DRAWINGS

Preferred embodiments of the present invention are illustrated in the attached drawings in which:

FIG. 1a is a plan view of a front of a first preferred embodiment of the present invention;

FIG. 1b is a plan view of the back of the first preferred embodiment of the present invention;

FIG. 1c is a plan view of the interior of the first preferred embodiment the present invention;

FIG. 1d is a plan view of a picture card for use with the first preferred embodiment of the present invention;

FIG. 2 a is a plan view of a front of a second preferred embodiment of the present invention;

FIG. 2b is a plan view of a back of the second preferred embodiment of the present invention;

FIG. 2c is a plan view of the interior of the second preferred embodiment the present invention; and

FIG. 2d is a plan view of a picture card for use with the second preferred embodiment of the present invention.

### DETAILED DESCRIPTION OF THE PREFERRED EMBODIMENTS

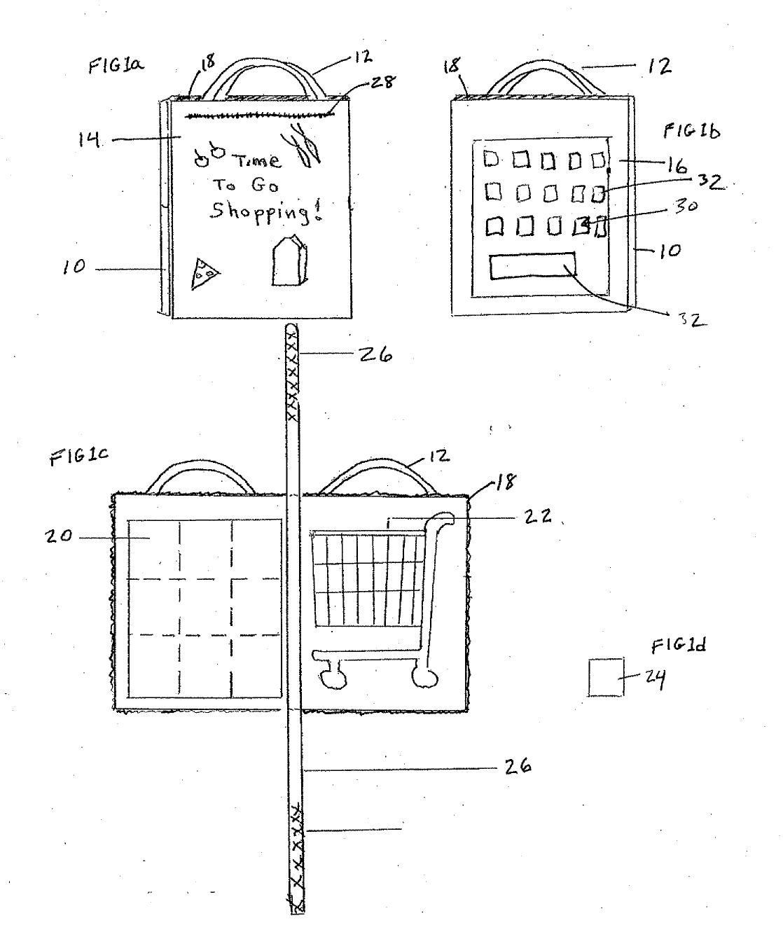

A first preferred embodiment of an educational toy according to the present invention is illustrated in FIGS. 1a to 1d. The educational toy is a tote 10 provided with handles 12 to enable it to be carried by a user. The tote has a front portion 14 and a back portion 16 held together in the closed position by a closure means 18. Closure means 18 can be any commonly utilized closure means such as a hook and eye fastener or a snap and dome fastener or as illustrated in the preferred embodiment, zipper type closure. When the closure 18 is released, the tote 10 opens similar to a book to reveal a plurality of small pockets 20 on one side for holding individual items and a larger pocket 22, on the other side, the purpose of which will now be explained. The first embodiment of the educational toy of the present invention is for use in shopping, preferably for grocery shopping. When the child is involved in the grocery shopping task in the manner as to be described the task is more pleasurable for both the child and parent. Before the shopping trip, the parent and child go over the shopping list and the child looks for cards 24 having pictures matching the items on the shopping list. The picture cards 24 of the items to be purchased during shopping are placed in the plurality of pockets 20 on the one side of the tote 10. The tote 10 is provided with a strap 26 to enable the tote 10 to be attached to a grocery cart. Alternatively, the handle 12 may also be adapted to allow the tote to be attached to a support such as a grocery cart, chair back, etc. At the grocery store as an item on the list is found, the picture card 24 for the item is taken out of the pocket 20 on the one side and placed in the large pocket 22 on the other side of the tote 10. In this embodiment, the large pocket 22 has the appearance of a shopping cart so that the child is placing the items in the shopping cart following along with the parent. If all of the items on the shopping list have been removed from the plurality of pockets 20 cards 24 relating to other items still remaining on the shopping list, may be removed from a larger pocket 28 on the exterior of the tote 10 and placed in the individual pockets 20, so the shopping experience may be continued.

The cards 24 will be selected having a picture matching typical items on the shopping list. For example, some of the cards may have fruits and vegetables commonly purchased in a grocery store such as potatoes, carrots, tomatoes, broccoli, apples, bananas, grapes, etc. Other cards will have dairy items such as milk, yogurt, egg, cheese, etc. Another series of cards would have grain products such as cereal, bread, crackers, etc. While another series of cards would include miscellaneous items such as soups, peanut butter jam, pizza and personal care products such as toothpaste, soap, etc.

Preferably, the educational toy may also be provided with a simulated calculator 30 on the back of the tote so that the child may practice the numbers using the simulated calculator 30. One or more of the buttons 32 of the calculator 30 may be provided with a sound producing device such as an air bladder or an electronic touch button such that when the button 32 associated with the number or total is touched a sound is produced.

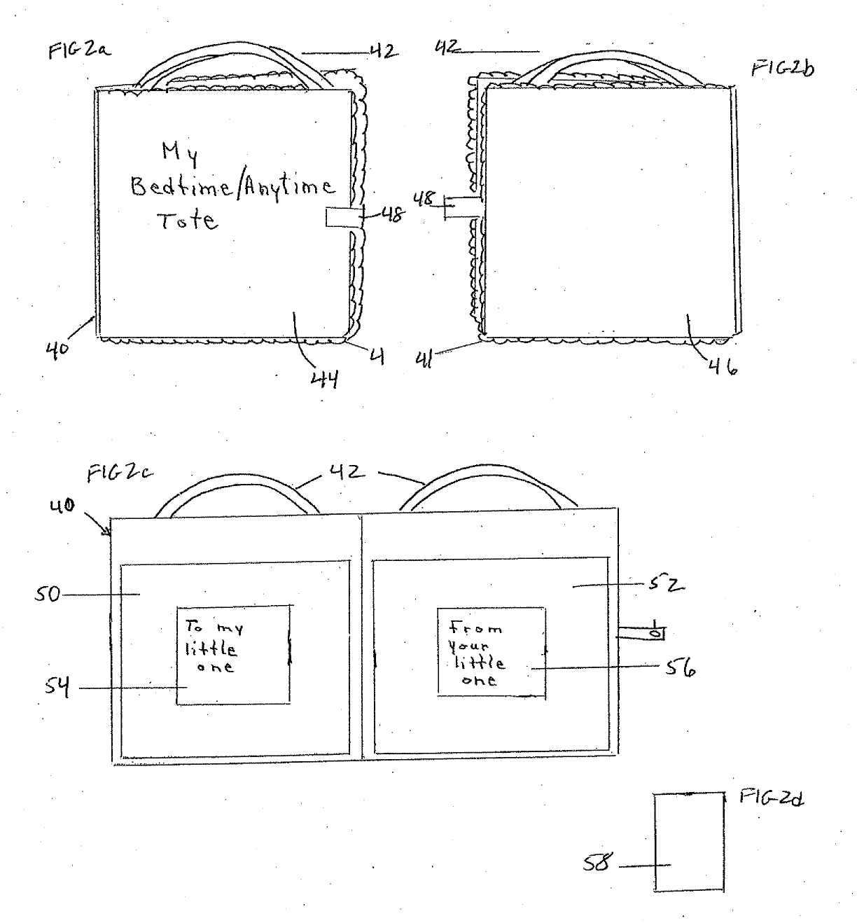

A second embodiment of the educational toy that present invention is illustrated in FIGS. 2a to 2d. Similar to the first embodiment, the educational toy is a tote 40 provided with handles 42 to enable it to be carried by a user. This tote 40 also has a front portion 44 and a back portion 46, held together in the closed position by a closure means 48 such as a hook and loop type closure. Similar to the first embodiment, the tote 40 may be opened similar to a book into an open position. This embodiment of the educational toy of the present invention is designed for use at bedtime to allow parents and children to enjoy bedtime and have some positive interaction each night no matter how busy they may have been during the day. The educational toy of this embodiment may be hung on a doorknob or hook during the day by the handles 42 and placed on the bed at bedtime, Decorative trim 41 may be placed around the exterior of the tote 40 to enhance the appearance of the tote 40. When the closure 48 is released and the tote 40 opens, the pockets 50 and 52 on the interior of the tote 40 are revealed. These pockets 50 and 52 are designed to hold a bedtime buddy or stuffed animal on one side and a bedtime story in the other side. In use the child places their choice of bedtime buddy and book in the pockets 50 and 52 as they get ready for bed. When the child is in the bed and the tote 40 is opened they are ready to cuddle with the bedtime buddy and listen to the chosen bedtime story.

To enhance the educational experience, the tote 40 may be provided with smaller pockets 54 and 56 attached to the larger pockets 50 and 52 on the interior. The small pocket 54 on one side may be utilized for note cards 58 from the parent to the child and the pocket 56 on the other side may be utilized for note cards 58 from the child to parent. Depending upon the age of the child the note cards 58 may be illustrations or for older children there may be sayings provided on the card. For example for older children, a card 58 may say for example “I was proud of you today”, while for younger children they may be illustrations such as hearts or other prizes or messages provided on the cards. Each night the parent would place a different card 58 in the pocket 54 so the child will look forward to the surprise note. These notes can also lead to discussions of the good moments of the day or problems that may have arisen during the day. The notes lead to positive interaction between parents and their children leaving a positive and loving impression as the last memory of the day.

The tote of this embodiment is especially suitable for children who may be staying at a place other than their own house, such as for example, when they're visiting relatives or traveling. Having a regular routine of the bedtime in such circumstances, can result in a positive experience and make the time away from home go more smoothly. This tote may also be utilized with children, who spend time away from home during the day, such as at a sitter or day care, and can be utilized with younger children for naptime during the day.

Other educational toys according to the present invention may be designed to teach and occupy children during other routine activities such as traveling or waiting for appointments, etc.

While various preferred embodiments of the present invention have been described herein in detail, it will be appreciated that variations may be made thereto without departing from the spirit of the invention. The preferred embodiments are provided for illustration and the invention is not limited to those embodiments.

1. An educational toy for use during the routine activity of grocery shopping comprising a tote provided with handles to enable it to be carried by a user, the tote having a front portion and a back portion, a releasable closure means to hold the back and front portions together in a closed position, the closure means in an open position allowing the tote to open similar to a book to reveal at least one pocket on one side in the interior for holding individual items and at least one pocket on the other side for also holding items, the educational toy further including a plurality of cards having pictures of grocery items thereon, the one side of the interior is provided with a plurality of individual pockets to hold cards having pictures of grocery items thereon, the other side having a pocket with a representation of a grocery shopping cart thereon, the cards representing the items on a shopping list in the individual pockets on the one side being removable from the individual pocket on the one side for placement in the pocket with the representation of the grocery cart on the other side thereby imitating grocery shopping.

2. An educational toy according to claim 1 wherein the releasable closure means is a zipper provided along the periphery of the front portion and back portion.

3. An educational toy according to claim 2 wherein the cards have pictures selected from fruits and vegetables, dairy items, grain products, miscellaneous items and personal care products.

4. An educational toy according to claim 3 wherein the cards have pictures selected from potatoes, carrots, tomatoes, broccoli, apples, bananas, grapes, milk, yogurt, egg, cheese, cereal, bread, crackers, soups, peanut butter, jam, pizza toothpaste, and soap.
